(19) United States
(12) Patent Application Publication
(10) Pub. No.: US 2016/0292713 A1
(43) Pub. Date: Oct. 6, 2016

(54) MEASURING USER ENGAGEMENT WITH SMART BILLBOARDS

(71) Applicant: Yahoo! Inc., Sunnyvale, CA (US)

(72) Inventors: Jian Chen, Palo Alto, CA (US); Romualdas Strimaitis, Los Altos Hills, CA (US)

(21) Appl. No.: 14/675,004

(22) Filed: Mar. 31, 2015

(51) Int. Cl. G06Q 30/02

(52) U.S. Cl. CPC G06Q 30/0242

(57) ABSTRACT

Methods and apparatus are described by which advertising channels in public spaces are configured to deliver adaptive and targeted advertising in real time. Real-time, contextual information is used to make determinations about the likely audience currently in position to view an advertising channel (e.g., a digital billboard). Appropriate advertisements are then selected based on those determinations. Techniques for measuring user engagement with advertising content are also described.

### BACKGROUND

In the past few years, online advertising has quickly become the primary channel by which advertisers reach out to consumers. The ubiquity of mobile devices and the ability to craft individualized marketing strategies to meet the needs and interests of specific consumers have made a compelling case for such techniques as the most efficient use of marketing budgets. Nevertheless, a significant portion of such budgets is still devoted to more traditional channels.

For example, advertising in public places (e.g., roadside billboards, public transit, etc.) continues to be an important channel for advertisers even though it does not offer the kind of individual targeting by which online techniques are characterized. However, most public space advertising adheres to business models that are decades old. For example, many roadside billboards are still static printed images that must be manually installed and remain in place for long periods of time relative to the lifespan of an online ad. More recently, some billboards have been implemented as large screens that display a fixed rotation of images. But while these billboards represent a step in the direction of the digital age, they lag far behind their online counterparts in a number of respects.

### SUMMARY

According to various implementations, methods, apparatus, systems, and computer program products are provided in which sensor data are received representing an audience that includes a plurality of people in position to substantially simultaneously view content. The sensor data is generated by one or more sensors in proximity to a location at which the content is presented. The sensor data are processed to determine a level of user engagement with the content for at least a portion of the audience.

According to some implementations, the content is advertising content presented on an electronic public advertising display at the location. The advertising content may be dynamically presented in a manner that is responsive to at least some of the sensor data. According to other implementations, the advertising content is a static, printed image presented at the location.

A further understanding of the nature and advantages of various implementations may be realized by reference to the remaining portions of the specification and the drawings.

### BRIEF DESCRIPTION OF THE DRAWINGS

FIG. 1 is a simplified representation of a network computing environment in which particular implementations enabled by the present disclosure may be practiced.

FIG. 2 is a simplified block diagram of an example of an electronic public advertising display that may be used with various implementations enabled by the present disclosure.

FIG. 3 is a flowchart illustrating operation of a particular class of implementations enabled by the present disclosure.

FIG. 4 is a flowchart illustrating operation of another class of implementations enabled by the present disclosure.

### DETAILED DESCRIPTION

Reference will now be made in detail to specific implementations enabled by the present disclosure. Examples of these implementations are illustrated in the accompanying drawings. It should be noted that these examples are described for illustrative purposes and are not intended to limit the scope of this disclosure. Rather, alternatives, modifications, and equivalents of the described implementations are included within the scope of this disclosure as defined by the appended claims. In addition, specific details may be provided in order to promote a thorough understanding of the described implementations. Some implementations within the scope of this disclosure may be practiced without some or all of these details. Further, well known features may not have been described in detail for the sake of clarity.

This disclosure describes techniques by which advertising channels in public spaces are configured to deliver adaptive and targeted advertising in real time. However, in contrast with the individualized approach represented by most online advertising models, the techniques described herein use a variety of information to make determinations about the audience currently in position to experience an advertising channel (e.g., view a billboard or an ad on public transportation) and select appropriate advertisements based on those determinations. The types of information on which the determinations are made include real-time information relating to the current context of the advertising channel and the target audience. However, instead of relying on “personalization” like online advertising, the techniques described herein rely on “grouplization,” i.e., selection of advertising content based on an aggregate representation of the target audience that is derived, at least in part, from real-time information. Some examples will be illustrative.

According to one example, a digital billboard adjacent a busy freeway might be instrumented with or located near traffic sensors that detect information about the context of the vehicles approaching the billboard, e.g., the number and average speed of the vehicles. Such information might be used in conjunction with information about the time of day and/or the day of the week (e.g., Monday morning rush hour) to select advertisements for display that would appeal to an expected demographic and to display the advertisements for durations that are commensurate with the level of traffic congestion. In another example, such a billboard could be instrumented with one or more digital cameras that capture images or video of the vehicles on the freeway that are approaching the billboard. Using image recognition techniques, information about the makes and models of the vehicles could be used to further inform the selection of advertisements by including real-time information that correlates with demographic characteristics of at least some of the target audience.

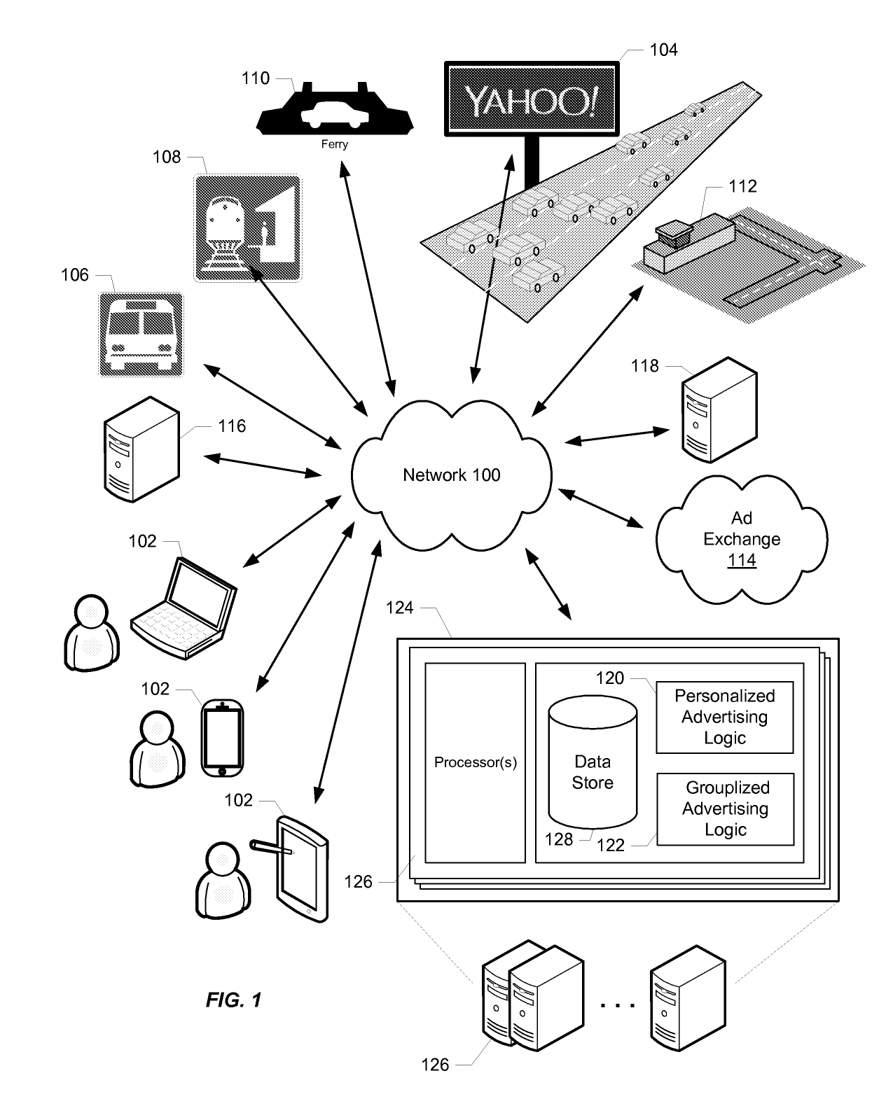

FIG. 1 shows a network environment in which the techniques enabled by this disclosure may be implemented. The depicted network 100 may include any subset or combination of a wide variety of network environments including, for example, TCP/IP-based networks, telecommunications networks, wireless networks, cable networks, public networks, private networks, wide area networks, local area networks, the Internet, the World Wide Web, intranets, extranets, etc. Client devices 102 may be any device capable of connecting to network 100 and interacting with the great diversity of sites, networks, and systems (not shown) interconnected by or integrated with network 100 in ways that result in the presentation of advertisements on client devices 102. Such devices include, but are not limited to, mobile devices (e.g., cell phones, smart phones, smart watches, tablets, etc.), personal computers (e.g., laptops and desktops), set top boxes (e.g., for cable and satellite systems), smart televisions, and gaming systems.

The network environment also includes a variety of electronic public advertising displays represented by digital billboard 104. As used herein, an electronic public advertising display is any type of electronic display or screen capable of displaying images or video and that is located in a place accessible to at least a portion of the general public or that is viewable from a public place. Electronic public advertising displays that may be used to display advertisements in accordance with the techniques described herein are contemplated as being associated with various modes of transportation and/or the stations, terminals, or depots associated with those forms of transportation such as, for example, buses 106, trains 108, ferries 110, and commercial aircraft 112.

Advertisements presented on client devices 102 and electronic public advertising displays (e.g., digital billboard 104) may be selected and presented in a wide variety of ways. For example, ads might be selected and presented by means of an advertising exchange 114, i.e., an online marketplace in which connections are made between the inventory of online publishers (e.g., advertising space on web page) or electronic public advertising display providers (e.g., digital billboard providers, transit display providers, etc.) and the inventory of advertisers (e.g., advertisements or advertising content). Advertisers pay according to a variety of economic models for events (e.g., ad impressions, users clicking on ads, conversion events, etc.) relating to the placement of their advertisements. Third parties (e.g., brokers, agents, agencies, consortiums, networks, etc.) might also participate in the exchange, making connections between publishers and advertisers and, in some cases, representing and managing the advertising campaigns of multiple entities in the exchange. Alternatively, some entities (represented by publisher server 116 and advertiser server 118) might establish direct relationships and deals with their advertising partners.

For the sake of clarity and simplicity, FIG. 1 and the following description assume an implementation in which the selection of advertising content (represented by personalized advertising logic 120 and “grouplized” advertising logic 122) is implemented as part of a platform 124 that also transmits ads to client devices and electronic public advertising displays for presentation. As will be understood, platform 124 may conform to any of a wide variety of architectures such as, for example, a distributed platform deployed at one or more co-locations, each implemented with one or more servers 126. Data store 128 is also shown as part of platform 124 and may include, among other things, advertising content as well as various other data that may be used in the selection of ads. However, it should be noted that implementations are contemplated in which one or more of these functions or data sets operate or are stored remotely from the others (e.g., on other platforms such as 114, 116, or 118), and/or are under the control of one or more independent entities (e.g., publishers, advertisers, third parties in and out of an ad exchange, etc.).

It should also be noted that, despite references to particular computing paradigms and software tools herein, the logic and/or computer program instructions on which various implementations are based may correspond to any of a wide variety of programming languages, software tools and data formats, may be stored in any type of non-transitory computer-readable storage media or memory device(s), and may be executed according to a variety of computing models including, for example, a client/server model, a peer-to-peer model, on a stand-alone computing device, or according to a distributed computing model in which various functionalities may be effected or employed at different locations. In addition, any references to particular protocols herein are merely by way of example. Suitable alternatives known to those of skill in the art for all of these variations may be employed.

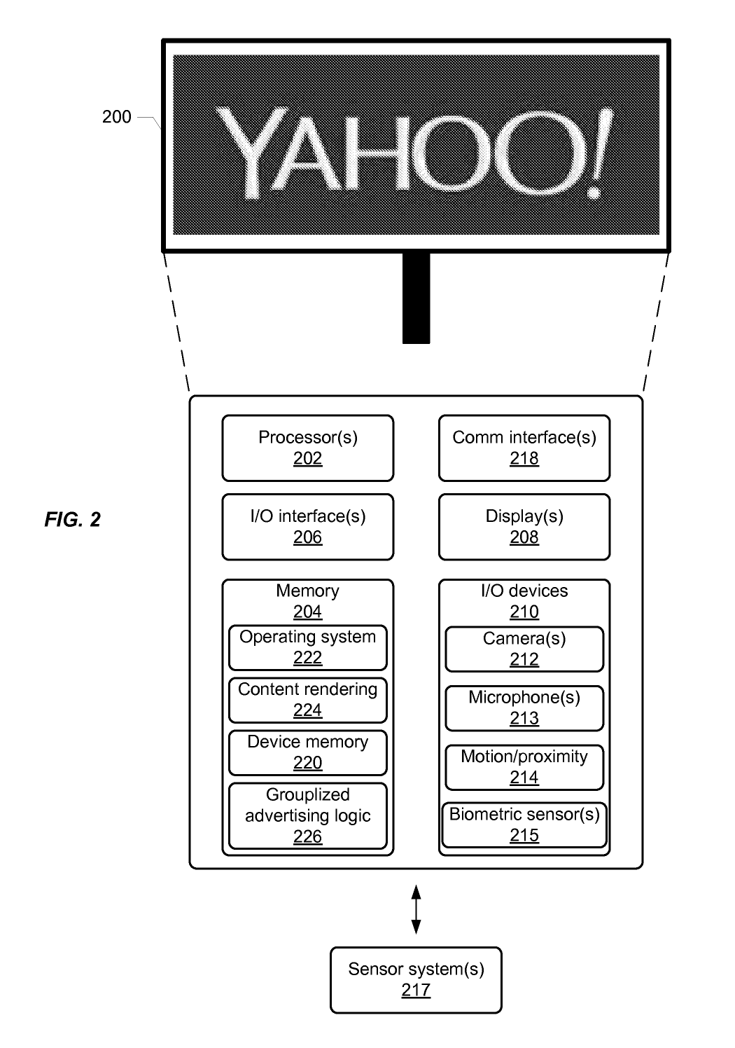

FIG. 2 illustrates an example of an electronic public advertising display (in this case a digital billboard) that may be used with various implementations enabled by the present disclosure. Digital billboard 200 includes (or has associated therewith) one or more processors 202 configured to execute stored instructions (e.g., in memory 204). Digital billboard 200 may also include (or have associated therewith) one or more I/O interface(s) 206 to allow communication with one or more displays 208 and one or more I/O devices 210. I/O interface(s) 206 may include, for example, an inter-integrated circuit (I2C) interface, a serial peripheral interface (SPI) bus, a universal serial bus (USB), an RS-232 interface, a media device interface, etc. I/O device(s) 210 may include, for example, one or more cameras 212, one or more microphones 213, one or more motion/proximity sensors 214, one or more biometric sensors 215 (e.g., fingerprint or retinal scanning, facial recognition, etc.). Sensor systems may be integrated and/or associated with the electronic public advertising display to varying degrees. For example, sensor systems can be integrated with and under the direct control of the electronic public advertising display, deployed near and communicating directly with the electronic public advertising display, and/or deployed nearby but operating with varying degrees of independence from the electronic public advertising display (e.g., as represented by sensor system(s) 217). For example, a camera or other type of sensor could be tightly integrated with an electronic public advertising display as one of its I/O device or, alternatively, could be deployed and operated independently such as, for example, on an aerial surveillance drone or a satellite that communicates to a back end server (e.g., servers 126) independently of the electronic public advertising display. The range of variation should be apparent to those of skill in the art. The one or more displays 208 are configured to provide visual output to a target audience and may comprise any of a variety of suitable display technology.

Digital billboard 200 may also include one or more communication interfaces 218 configured to provide communications between digital billboard 200 and other devices (e.g., remote servers). Such communication interface(s) 218 may be used to connect to cellular networks, personal area networks (PANs), local area networks (LANs), wide area networks (WANs), and so forth. For example, communications interfaces 218 may include RF modules for a 3G or 4G cellular network, a WiFi LAN, and/or a Bluetooth PAN. Digital billboard 200 also includes one or more buses or other internal communications hardware or software (not shown) that allow for the transfer of data and instructions between the various modules and components of the system.

Memory 204 of digital billboard 200 includes device memory 220 which includes non-transitory computer-readable storage media that may be any of a wide variety of types of volatile and non-volatile storage media including, for example, electronic storage media, magnetic storage media, optical storage media, quantum storage media, mechanical storage media, and so forth. Device memory 220 provides storage for computer readable instructions, data structures, program modules and other data for the operation of digital billboard 200. As used herein, the term “module” when used in connection with software or firmware functionality may refer to code or computer program instructions that are integrated to varying degrees with the code or computer program instructions of other such “modules.” The distinct nature of the different modules described and depicted herein is used for explanatory purposes and should not be used to limit the scope of this disclosure.

Device memory 220 also includes at least one operating system (OS) module 222 configured to manage hardware resources such as I/O interfaces 206 and provide various services to applications or modules executing on processor(s) 202. Device memory 220 also includes a content rendering module 224, and may include a variety of other modules that are not depicted for the sake of clarity. Device memory 220 may also store (at least temporarily) content for rendering by module 224 and display on display 208. Device memory might also include logic that performs at least some of the data capture and/or processing associated with aggregating the real-time information captured for use in selecting advertisements as enabled by the present disclosure (e.g., as represented by “grouplized” advertising logic 226). It should be noted that in some implementations, some portions of digital billboard 200 (e.g., device memory 220) may be distributed across one or more other devices including servers, network attached storage devices, and so forth.

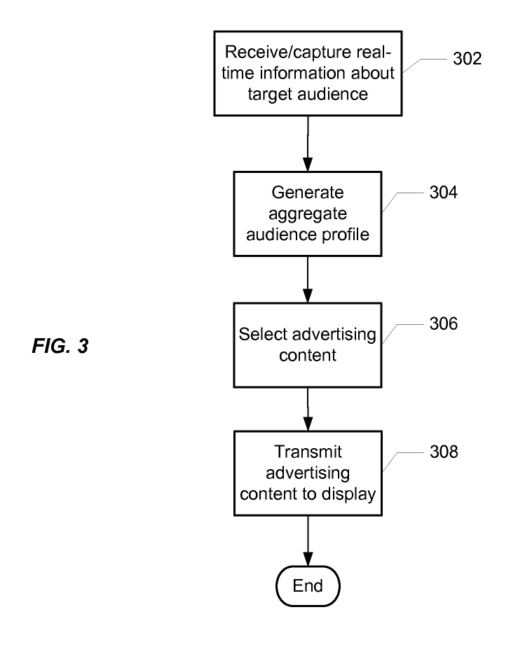

FIG. 3 illustrates the presentation of “grouplized” advertising content on an electronic public advertising display according to a particular implementation. The primary example of a use case described with reference to FIG. 3 assumes the electronic public advertising display is a digital billboard (e.g., digital billboard 104). It should be understood, however, that a wide variety of other electronic public advertising displays are contemplated including, for example, displays on public transportation (in or on vehicles, stations, shelters, etc.), in public places, in private establishments open or visible to the public (e.g., restaurants and bars, various types of retail locations, etc.), or even private establishments open to members only (e.g., private clubs, country clubs, etc.). The scope of the present disclosure should therefore not be limited by reference to specific use cases mentioned herein.

The digital billboard has one or more associated or nearby sensor systems that capture sensor data from which real-time information about the context in which the digital billboard is located may be derived (302). Such sensor systems might include, for example, one or more cameras, one or more microphones, one or more motion/proximity sensors (e.g., traffic sensing system), one or more biometric sensors, etc. As discussed above, such sensor systems might be integrated with the digital billboard to varying degrees without departing from the scope of this disclosure. For example, one or more cameras deployed near the digital billboard might capture images or video of vehicles on the highway or street from which the digital billboard is visible, and the camera(s) might communicate directly with the digital billboard via a wired connection or a wireless connection (e.g., from a fixed location or an aerial drone). In another example, an independently operated traffic sensing system might be deployed near the billboard that senses the speed and/or the congestion of traffic on the nearby highway, the data from which might be acquired by a back end system (e.g., server 126). In yet another example, information captured by one or more cell towers deployed and/or under control of telecommunication service providers might be leveraged in a variety of ways to provide information about the context of the digital billboard. Those of skill in the art will appreciate the wide variety of sensor systems that may be used to provide real-time information about the context of an electronic public advertising display as enabled by the present disclosure.

The nature of the real-time information may vary considerably as well. For example and as discussed above, such information might represent the size of the target audience in various ways. That is, traffic sensor data, image/video data, audio data, etc., can be used to count or estimate the number of vehicles on the road, from which the size of the audience can be estimated; image/video data can be used to identify the makes and/or models of particular vehicles in the vicinity; mobile device data or image/video data can be used to identify specific individuals in the target audience; vehicle navigation and/or tracking data can be used to identify specific vehicles and/or drivers; light sensors can measure the ambient light; temperature sensors can measure the ambient temperature; etc. And with the increasing instrumentation of ordinary objects such as smart appliance, vehicles, etc. (i.e., the “Internet of Things”), the sources of data and information that may be used to enable the techniques described herein are virtually limitless. That is, any sensors or sensor systems that generate data or collect information in real-time that represent some aspect of the context in which the electronic public advertising display is situated (including the target audience) may be used.

The real-time information is then used to generate or determine an aggregate audience profile that represents one or more demographic characteristics of the target audience (304). As will be appreciated, the real-time information may be used with or without additional information to inform this determination. For example, traffic sensor data representing the number and speed of vehicles on a highway can be used in conjunction with information about the time of day, day of the week, and the geographic location of the digital billboard to generate an aggregate audience profile that represents demographic information about the motorists expected to be on the highway under those condition. That is, the demographics of motorists during rush hour on a weekday in Silicon Valley can be expected to be very different from the demographics of mid-afternoon traffic in that same location on a weekend or Friday evening traffic headed into San Francisco. And the level of traffic congestion might also be relevant. For example, advertising content from a local business (e.g., a rest stop) at the next freeway exit might be presented if there is a high level of congestion.

In another example, image recognition techniques can be used to identify the makes, models, and years of vehicles on a highway, from which demographic information relating to the socioeconomic status of the corresponding drivers can be made using, for example, previously stored marketing information. Such information can then be aggregated to represent all or at least a portion of the target audience. In yet another example, cell tower data, mobile app location data, or image data can be used to identify specific individuals in the target audience, the demographic data (e.g., as obtained from a marketing or user database) for which can then be aggregated to represent all or a portion of the target audience. In still another example, vehicle navigation/tracking data from vehicles equipped with such systems could be used to identify specific vehicles and/or vehicle owners. Again, those of skill in the art will appreciate from the diversity of these examples the great variety of ways in which an aggregate audience profile may be determined or generated using real-time information representing the context of the electronic public advertising display and/or additional information from a wide variety of sources.

Advertising content is selected for presentation on the electronic public advertising display based at least in part on the aggregate audience profile (306). That is, the aggregate audience profile may be used to identify advertisements designed to appeal to all or a portion of the target audience as represented by the demographic information included in the profile. As will be appreciated, there are a large number of techniques by which this can be done, all of which may be used with implementations enabled by this disclosure. For example, if the aggregate audience profile represents a specific median income, advertising content can be selected that targets a range of income around that median. In another example, if the aggregate audience profile represents stay-at-home parents or guardians, advertising content can be selected that targets that group. The great diversity of ways in which advertising content can be correlated with the various demographics that can be determined as described herein are contemplated as being within the scope of this disclosure.

The real-time information representing the context of the electronic public advertising display may also be used in the selection of advertisements. That is, the real-time information may be used in generating the aggregate audience profile as well as in conjunction with the aggregate audience profile to select appropriate ads. For example, the time of day and geographic location of the digital billboard might be correlated with data representing nearby events (e.g., ball games, music festivals, etc.) or nearby businesses (e.g., restaurants) that might be of interest to the target audience to provide advertising content that relates to those events or businesses; e.g., the availability of tickets to a nearby ball game could be advertised, or the dinner special at a nearby restaurant could be advertised around 6 pm. In another example, the date and the current weather at the location of a digital billboard might be combined with the demographics of the target audience to display advertising for a ski resort. In another example, the time of day or ambient light data could be used to select advertising content that will display effectively under the current conditions (e.g., because of visibility).

The advertising content can then be presented on the electronic public advertising display (308). This may be accomplished in a variety of ways depending on the implementation and the number of parties involved in the advertising model. For example, an ad could be transmitted to a digital billboard from a store of advertising content on a backend server that is associated with the logic that determines the audience profile. Alternatively, the advertising content might be served to the digital billboard from a third party participating in an advertising exchange. As yet another alternative, the advertising content might be locally stored in a data store accessible to the electronic public advertising display.

As will be appreciated by those of skill in the art, implementations enabled by the present disclosure can be integrated with and/or leverage existing technological infrastructure and/or models for online advertising to varying degrees. For example, electronic public advertising displays can be integrated with an online advertising exchange that also delivers advertising content to more conventional target devices, thus leveraging existing infrastructure in a powerful new way. The advertising content may be the same as that being delivered to other types of devices, modified in some way, or designed specifically with the type of electronic public advertising display in mind. For example, banner ads that are displayed in browser windows on laptops or tablets might also be displayed without alteration on a digital billboard or a display on public transportation. Alternatively, existing advertising content might be modified or new content created specifically to accommodate any of the various characteristics (size, resolution, etc.) of the electronic public advertising display, the lighting conditions associated with the electronic public advertising display, etc. For example, font size, color schemes, image resolution, visual clutter, and the like might be factors that are considered in selecting, modifying, and/or creating content that is suitable for particular electronic public advertising display types.

Existing advertising content might also be modified or filtered in some way to ensure that only content appropriate to the context of the electronic public advertising display is presented. For example, advertising content intended for presentation on a digital billboard might need to comply with traffic safety regulations that prohibit video content from being displayed. Thus, any advertising content including video could, for example, be eliminated from the pool of available content or modified to remove video components. In another example, advertising content that may be appropriate for presentation to an adult on a mobile device might not be appropriate for presentation to a more general audience in a public place.

Advertisers might bid competitively for ad placement on electronic public advertising displays in a manner similar to current models, but suitably modified for group targeting based on the real-time information associated with the electronic public advertising displays. For example, advertisers could bid competitively for placement of their advertising content based on aggregate audience profiles, keywords or concepts related to such profiles, specific electronic public advertising displays or display types, specific times or times of day, etc. (or any combination of these). The advertising content would then be selected for presentation based on the results of such competitive bidding. As should be appreciated, any transaction model by which advertising content is made available for presentation in the context of online advertising may be adapted to present advertising content as described herein.

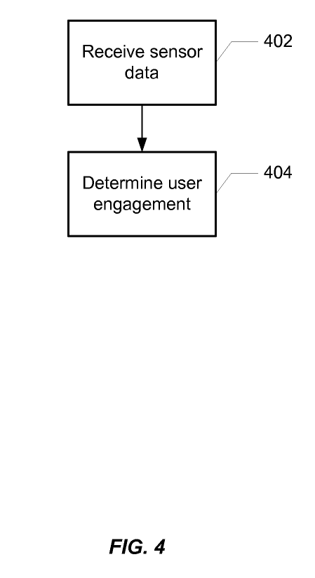

Notwithstanding the foregoing, it should be understood that advertising content may be selected and presented on electronic public advertising displays as described herein using infrastructure and models that are entirely independent of existing online advertising infrastructures and models. It should also be noted that at least some of the infrastructure included with an electronic public advertising display may be leveraged to determine user engagement with the advertising content presented. Such a capability might be useful, for example, for the purpose of demonstrating the effectiveness of a particular ad channel, as a basis for pricing, as a trigger for registering a conversion event for which an advertiser would pay, etc. An example of a specific implementation for measuring or determining user engagement will be described with reference to the flowchart of FIG. 4.

That is, in addition to using real-time information derived from sensor data (e.g., from sensors 212-217 of FIG. 2) to select advertising content, such sensor data may also be used to determine a level of user engagement with advertising content. As discussed above with reference to FIG. 3, such sensor systems might be integrated with, associated with, or operated independently of the advertising content display. And any of the sensor systems and sensor data suitable for generating real-time information for ad content selection may also be used to determine user engagement.

Referring to FIG. 4, sensor systems associated with the advertising content generate sensor data that are in some way representative of an audience of people in position to view the advertising content (402). For example, the sensor data might represent vehicle traffic information on a highway adjacent a billboard. In another example, the sensor data might represent the number of individuals in the audience, e.g., as determined using an image recognition technique on an image of a viewing area from which the advertising content is visible. In another example, the sensor data might represent sound captured near the location from which certain keywords spoken by members of the audience might be detected. In another example, the sensor data might include motion/proximity sensor data that captures movement (e.g., speed, acceleration, pausing, etc.) of objects (e.g., people, vehicles, etc.) in the vicinity of the advertising content.

The sensor data are processed to determine a level of user engagement with the advertising content for at least a portion of the audience (404). This may be done in a variety of ways depending on the type of sensor data. For example, image data or motion/proximity sensor data may be processed to determine whether any members of the audience paused or slowed down near the advertising content, from which it may be inferred that the pause or slowing was in response to the advertising content (e.g., a measurement of “dwell time”). In another example, image or video data may be processed to determine whether any individuals looked directly at the advertising content (e.g., using image recognition and/or eye tracking techniques). In another example, audio data captured by one or more microphones may be processed using speech recognition techniques to identify keywords relating to the advertising that are spoken by members of the audience. In yet another example, traffic sensor data may be processed to determine the number and/or speed of passing vehicles. In still another example in which the advertising display includes a touch screen or other kind of interface, direct user interaction with the advertising content could be measured.

As described above, various types of data (e.g., cell tower data, mobile app location data, image data, etc.) can be used to identify specific individuals in an audience in position to view advertising content. Similarly, vehicle navigation/tracking data from vehicles equipped with such systems could be used to identify specific vehicles and/or vehicle owners. Demographic data (e.g., as obtained from a marketing or user database) for the audience can thus be determined for the purpose of, for example, determining whether and/or the degree to which the demographic profile of the audience corresponds to a target demographic.

As will be appreciated, the various measures of user engagement with advertising content enabled by the present disclosure may be used in a variety of ways and for a variety of purposes. For example, they might be used to report on the volume of audience traffic or the audience demographic for a particular location as an inducement to advertisers who might be interested in presenting their advertising content at that location. In another example, measures of user engagement might be used to set rates for advertising locations and/or to factor into competitive bidding by advertisers for placing their ads at such locations.

In another example, when a measure of user engagement reaches a particular level or threshold, this might correspond to a “conversion” event that triggers a transaction according to an economic arrangement between parties in an advertising market. In conventional online advertising “conversion” events typically represent actions taken by consumers for which advertisers are willing to pay, e.g., selecting a banner ad or a sponsored link in a list of search results, purchasing a product, providing contact information, and the like. As the context of public advertising has not been amenable to the use of such techniques, it has been difficult for advertisers to determine whether their investments in such advertising channels are effective. The techniques for determining user engagement with advertising content enabled by the present disclosure provide mechanisms by which the effectiveness of such advertising channels can be measured.

For example, if it can be determined or estimated from sensor data associated with a public advertising display that more than some specific number of individuals were in a position to view specific advertising content, the placement of that content could be considered to be successful resulting in the advertiser being charged for its placement. In another example, if it can be determined or inferred from sensor data that one or more individuals slowed down, paused, or interacted with displayed advertising content, such events could be reported as conversion events for which the advertiser would be charged. In yet another example, if demographic information of an audience can be derived from sensor data and correlated with a particular time of day and one or more days of the week, this information can be used by, for example, a publisher to market that advertising channel to advertisers or as the basis for demonstrating that a particular demographic was successfully delivered to a particular advertiser. Those of skill in the art will appreciate a wide variety of additional examples by which user engagement with advertising content may be measured or determined, and the various ways such information may be used.

It will also be understood by those skilled in the art that changes in the form and details of the implementations described herein may be made without departing from the scope of this disclosure. For example, references to “smart billboards” or the “public” nature of the presentation of advertising content should not be used to unduly limit the scope of this disclosure. As described above, implementations using a variety of types of electronic public advertising displays that are deployed at a wide variety of locations are contemplated. Moreover, it will be appreciated that advertising content is only an example of the broader range of digital content that may be presented in accordance with the techniques described herein.

In another example, techniques for determining user engagement with advertising content have been described with reference to the dynamic electronic public advertising displays enabled by the present disclosure. However, implementations are contemplated in which user engagement may be determined for any type of publicly viewable advertising content including, for example, conventional printed images, conventional digital billboards, etc. That is, conventional advertising can be accompanied by suitable sensor systems as described above to capture data that may then be processed to determine user engagement. The scope of this disclosure should therefore not be interpreted to limit the described user engagement techniques by reference to other implementations described herein.

Finally, although various advantages, aspects, and objects have been described with reference to various implementations, the scope of this disclosure should not be limited by reference to such advantages, aspects, and objects. Rather, the scope of this disclosure should be determined with reference to the appended claims.

What is claimed is:

1. A computer-implemented method, comprising:
receiving sensor data representing an audience that includes a plurality of people in position to substantially simultaneously view content, the sensor data being generated by one or more sensors in proximity to a location at which the content is presented; and
processing the sensor data to determine a level of user engagement with the content for at least a portion of the audience.

2. The method of claim 1, wherein the content is advertising content presented on an electronic public advertising display at the location.

3. The method of claim 2, wherein the advertising content is dynamically presented in a manner that is responsive to at least some of the sensor data.

4. The method of claim 1, wherein the content is advertising content comprising a static, printed image presented at the location.

5. The method of claim 1, wherein the sensor data represent one or more of vehicle traffic information near the location, a number of individuals in the audience, an image of a viewing area from which the content is visible, sound captured near the location, or biometric data representing one or more members of the audience.

6. The method of claim 1, wherein the sensor data represent an image of the viewing area, the method further comprising processing the image data using an image recognition technique.

7. The method of claim 1, wherein processing the sensor data results in generation of user data corresponding to individuals in the audience.

8. The method of claim 7, wherein processing the sensor data to determine the level of user engagement with the content includes processing the user data to determine whether the audience corresponds to a target demographic.

9. The method of claim 1, wherein processing the sensor data to determine the level of user engagement with the content includes determining one or more of (1) whether any members of the audience slow or pause near the content, (2) a number of the people in the audience, (3) a rate at which the people in the audience pass the content, (4) whether any members of the audience look at the content, or (5) whether any members of the audience speak one or more keywords relating to the content.

10. The method of claim 1, further comprising triggering a transaction in an online advertising exchange in response to the level of user engagement.

11. A system, comprising one or more computing devices in communication via a network with one or more sensors associated with content, the one or more computing devices being configured to:
receive sensor data representing an audience that includes a plurality of people in position to substantially simultaneously view the content, the sensor data being generated by the one or more sensors in proximity to a location at which the content is presented; and
process the sensor data to determine a level of user engagement with the content for at least a portion of the audience.

12. The system of claim 11, wherein the content is advertising content presented on an electronic public advertising display at the location.

13. The system of claim 12, wherein the advertising content is dynamically presented in a manner that is responsive to at least some of the sensor data.

14. The system of claim 11, wherein the content is advertising content comprising a static, printed image presented at the location.

15. The system of claim 11, wherein the sensor data represent one or more of vehicle traffic information near the location, a number of individuals in the audience, an image of a viewing area from which the content is visible, sound captured near the location, or biometric data representing one or more members of the audience.

16. The system of claim 11, wherein the sensor data represent an image of the viewing area, and wherein the one or more computing devices are further configured to process the image data using an image recognition technique.

17. The system of claim 11, wherein the one or more computing devices are configured to process the sensor data to generate user data corresponding to individuals in the audience.

18. The system of claim 17, wherein the one or more computing devices are configured to process the sensor data to determine the level of user engagement with the content by processing the user data to determine whether the audience corresponds to a target demographic.

19. The system of claim 11, wherein the one or more computing devices are configured to process the sensor data to determine the level of user engagement with the content by determining one or more of (1) whether any members of the audience slow or pause near the content, (2) a number of the people in the audience, (3) a rate at which the people in the audience pass the content, (4) whether any members of the audience look at the content, or (5) whether any members of the audience speak one or more keywords relating to the content.

20. The system of claim 11, wherein the one or more computing devices are further configured to trigger a transaction in an online advertising exchange in response to the level of user engagement.

21. A computer program product, comprising one or more computer-readable media having computer program instructions stored therein, the computer program instructions being configured such that, when executed by one or more computing devices, the computer program instructions cause the one or more computing devices to:
receive sensor data representing an audience that includes a plurality of people in position to substantially simultaneously view content, the sensor data being generated by one or more sensors in proximity to a location at which the content is presented; and
process the sensor data to determine a level of user engagement with the content for at least a portion of the audience.
